(19) United States
(12) Patent Application Publication
(10) Pub. No.: US 2012/0298881 A1
(43) Pub. Date: Nov. 29, 2012

(54) SPECTROPHOTOFLUOROMETER AND FLUORESCENCE DETECTOR FOR LIQUID CHROMATOGRAPH

(76) Inventor: Izumi Ogata, Mito (JP)

(21) Appl. No.: 13/575,734

(22) PCT Filed: Nov. 4, 2010
(86) PCT No.: PCT/JP2010/006478

§ 371 Date: Jul. 27, 2012

(30) Foreign Application Priority Data
Jan. 28, 2010 (JP) 2010-016152

(51) Int. Cl. G01J 3/443

(52) U.S. Cl. 250/432 R

(57) ABSTRACT

Disclosed is a spectrophotofluorometer, which can shorten a measuring time by efficiently obtaining a three-dimensional spectral disposition, reduce sample deterioration and reduce the size of the obtained data. The spectrophotofluorometer is provided with a sample cell housing a sample, the components of which are analyzed; an excitation light side spectroscope for irradiating onto the sample cell excitation light with a predetermined wavelength; a fluorescence side spectroscope for dispersing the fluorescence from the sample cell by scanning a predetermined range of wavelength; a fluorescence detector for detecting the fluorescence from the fluorescence side spectroscope; and a computer for obtaining a three-dimensional spectral disposition of the fluorescence intensity in the sample on the basis of the wavelength and the intensity of the fluorescence detected by the fluorescence detector while changing the wavelength of the excitation light irradiated onto the sample cell by the excitation light side spectroscope. The computer sets a plurality of combinations of the range of wavelengths of the excitation light dispersed by the excitation light side spectroscope and the range of wavelengths of the fluorescence dispersed by the fluorescence side spectroscope.

### BACKGROUND

The present invention relates to a fluorescence spectrophotometer, and a fluorescence detector for a liquid chromatograph.

Fluorescence spectrophotometers are provided with a sample cell that houses a sample, an excitation light side spectroscope that disperses light generated from a light source, an emission side spectroscope that disperses emission light generated when the excitation light dispersed by the excitation light side spectroscope is irradiated onto the sample, and a detector that detects the emission light sent from the emission side spectroscope.

As a method for determining the wavelength of emission light so as to identify components of a sample, there has been proposed a technique of respectively scanning the wavelength of excitation light and the wavelength of emission light, obtaining a three-dimensional spectrum on which the excitation light wavelength, the emission light wavelength, and the emission light intensity are plotted, comparing the three-dimensional spectrum with a preliminarily-obtained three-dimensional spectrum in a standard sample, and thereby determining the excitation light wavelength and the emission light wavelength specific to the sample (as is disclosed in Japanese Unexamined Patent Application Publication No. JP-A-06-109542).

### SUMMARY OF THE INVENTION

To obtain the three-dimensional spectrum in the aforementioned conventional technique, for example, when a scanning wavelength range is set to 300 nm to 800 nm, the emission light intensity is detected by a detector while the emission light wavelength is being scanned from 300 nm to 800 nm with the excitation light wavelength being fixed to 300 nm. Subsequently, the excitation light wavelength is increased by, for example, 10 nm to 310 nm and fixed, and the emission light intensity is detected by the detector while the emission light wavelength is being scanned from 300 nm to 800 nm. The emission light intensity is detected up to an excitation light wavelength of 800 nm in a similar manner, to thereby obtain the three-dimensional spectrum of the emission light intensity. The three-dimensional spectrum of the emission light intensity in the sample can be obtained by measuring the respective wavelengths in the excitation light wavelength range while sequentially scanning the emission light wavelengths as described above.

However, for example, when an operator intends to obtain data in a given wavelength range instead of the above entire wavelength range, it is necessary for the operator to input and set a start wavelength and a stop wavelength for the wavelength scanning with respect to each wavelength range since only the start wavelength and the stop wavelength can be set in the conventional apparatus, and it takes at least about one minute to obtain the three-dimensional spectrum of the emission light intensity. Accordingly, it takes a long time to perform all measurements desired by the operator.

Since the sample is always irradiated with the excitation light during the measurement of the three-dimensional spectrum, there is also a risk that a sample with low chemical stability is deteriorated or decomposed due to irradiation energy of the excitation light when a measuring time is long.

Moreover, since the obtained data of the three-dimensional spectrum includes the scanning wavelength of the excitation light, the scanning wavelength of the emission light, and the emission light intensity, the data has a large size, and a large load is applied to an arithmetic unit that performs data processing, so that a processing time is extended.

It is an object of the present invention to provide a fluorescence spectrophotometer and a fluorescence detector for a liquid chromatograph which shorten a time required for measuring a three-dimensional spectrum in a sample.

To achieve the above object, an embodiment of the present invention includes: a sample cell that houses a sample, the components of which are analyzed; an excitation light side spectroscope that irradiates excitation light with a predetermined wavelength onto the sample cell; an emission side spectroscope that disperses emission light from the sample cell by scanning a predetermined range of wavelengths; an emission light detector that detects the emission light from the emission side spectroscope; and a computer that obtains a three-dimensional spectrum of an emission light intensity in the sample on the basis of a wavelength and an intensity of the emission light detected by the emission light detector while changing a wavelength of the excitation light irradiated onto the sample cell by the excitation light side spectroscope, wherein the computer sets a plurality of combinations of a range of wavelengths of the excitation light dispersed by the excitation light side spectroscope and a range of wavelengths of the emission light dispersed by the emission side spectroscope.

The present invention can provide a fluorescence spectrophotometer and a fluorescence detector for a liquid chromatograph which can shorten a time required for measuring a three-dimensional spectrum in a sample.

### BRIEF DESCRIPTION OF THE SEVERAL VIEWS OF THE DRAWINGS

FIG. 1 is a configuration diagram illustrating a main configuration of a fluorescence spectrophotometer.

FIG. 2 is a screen view illustrating one example of a screen for setting conditions for obtaining three-dimensional fluorescence spectrum.

FIG. 3 is a graph showing a scanning region of the excitation light wavelength and the emission light wavelength.

FIG. 4 is a graph showing a scanning region of the excitation light wavelength and the emission light wavelength.

FIG. 5 is a configuration diagram illustrating a main configuration of a liquid chromatograph.

### DETAILED DESCRIPTION OF THE INVENTION

In the following, an embodiment of the present invention will be described by reference to the drawings.

### Embodiment

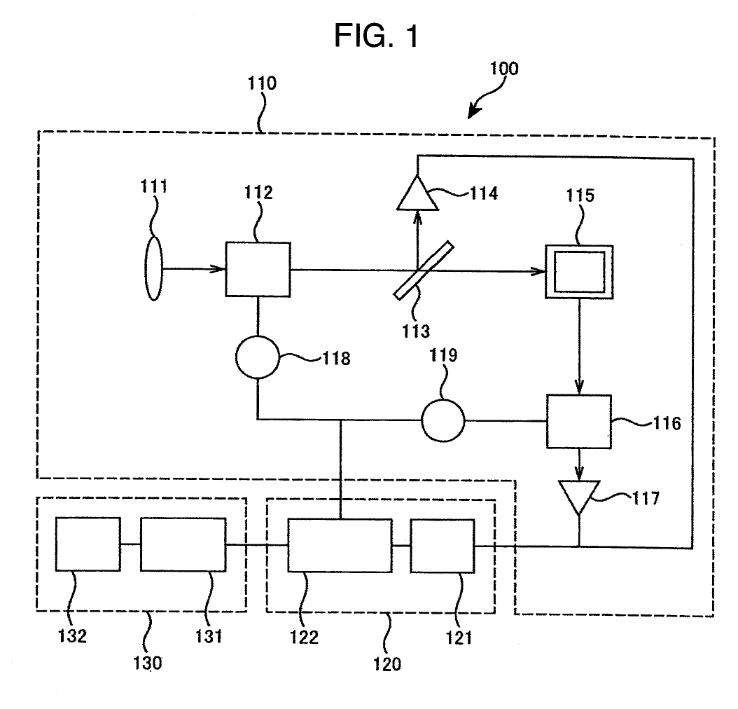

FIG. 1 is a configuration diagram illustrating a main configuration of a fluorescence spectrophotometer. As shown in FIG. 1, a fluorescence spectrophotometer 100 is composed of a photometer unit 110, a data processing unit 120, and an operation display unit 130. In the photometer unit 110, continuous light emitted from a light source 111 is dispersed as monochromatic excitation light by an excitation side spectroscope 112, and irradiated onto a measurement sample installed on a sample installation section 115 through a beam splitter 113. The beam splitter 113 disperses a portion of the excitation light, and a monitor detector 114 measures the intensity of the light, which is used for monitoring a variation in the light intensity of the continuous light emitted from the light source 111 and correcting the variation in the data processing unit 120. Emission light is emitted from the measurement sample due to the irradiation of the excitation light. The emitted emission light is dispersed into monochromatic light by an emission side spectroscope 116, detected by a detector 117, and transmitted as an electric signal according to the light intensity of the emission light. The intensity signal of the emission light transmitted from the detector 117 is converted to a digital signal via an A/D converter 121 of the data processing unit 120, and introduced into a computer 122. The computer 122 stores the obtained intensity signal of the emission light in a storage section provided inside the computer 122 as data correlated with the wavelength of the excitation light obtained by dispersing the continuous light by the excitation side spectroscope 112 and the wavelength of the emission light obtained by dispersing the emission light by the emission side spectroscope 116. The data can be also displayed on a display section 131 when an operator uses an operation section 132 of the operation display unit 130.

The excitation side spectroscope 112 and the emission side spectroscope 116 are respectively composed of a diffraction grating that spectrally resolves incident light, and a slit that receives the spectrally-resolved incident light and selectively extracts light with a particular wavelength, i.e., monochromatic light from the spectrally-resolved incident light. The wavelength of light to be transmitted through the slit is determined by the position of the slit for receiving the spectrally-resolved incident light. In a normal spectroscope, the wavelength of light to be transmitted through a slit is determined by fixing the position of the slit and rotating a diffraction grating little by little. The diffraction grating of the excitation side spectroscope 112 is rotated by an excitation side pulse motor 118 via a gear or a cam. The diffraction grating of the emission side spectroscope 116 is also rotated by an emission side pulse motor 119 via a gear or a cam.

When the operation section 132 of the operation display unit 130 instructs the photometer unit 110 to perform emission light measurement of the measurement sample, the computer 122 of the data processing unit 120 drives the excitation side pulse motor 118 according to a measuring program stored in the unillustrated storage section. The diffraction grating of the excitation side spectroscope 112 is thereby rotated, so that the wavelength of the excitation light to be extracted by the excitation side spectroscope 112, i.e., the wavelength of the dispersed monochromatic light is set.

Similarly, the computer 122 of the data processing unit 120 drives the emission side pulse motor 119 according to the measuring program stored in the unillustrated storage section. The diffraction grating of the emission side spectroscope 116 is thereby rotated, so that the wavelength of the emission light to be extracted by the emission side spectroscope 116, i.e., the wavelength of the dispersed monochromatic light is set. A mechanical section that sets the wavelength of the monochromatic light as described above is called wavelength drive system.

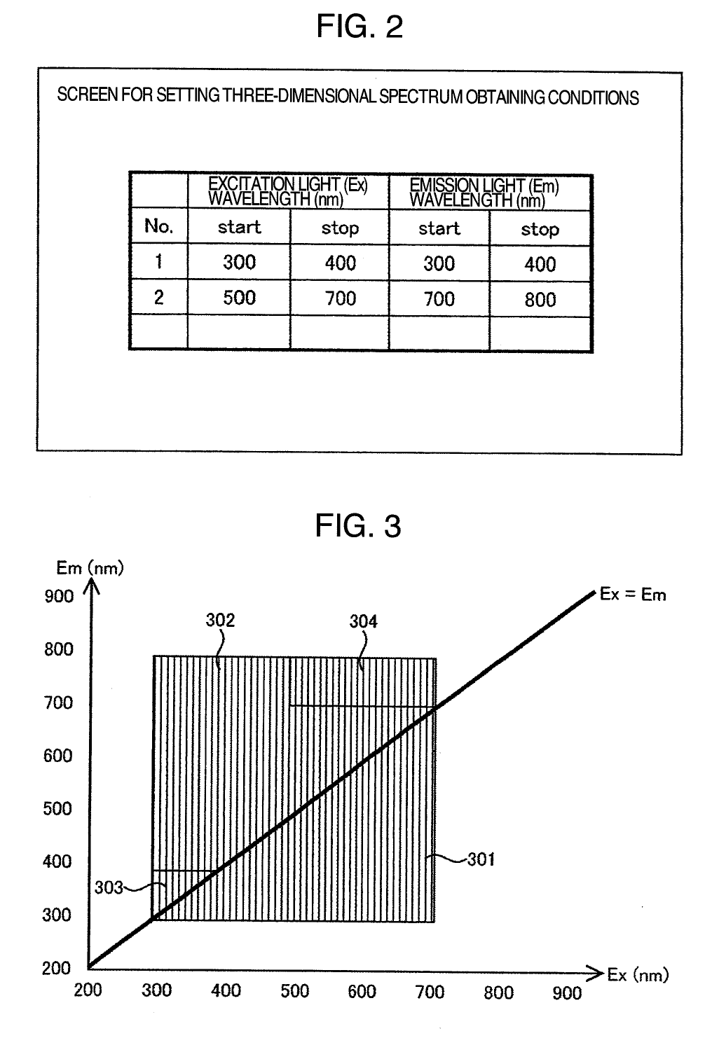

In the measurement of the fluorescence spectrophotometer, a scanning range of the wavelength of the excitation light and a scanning range of the wavelength of the emission light are set first. FIG. 2 is a screen view illustrating one example of a screen for setting three-dimensional spectrum obtaining conditions.

In the present embodiment, an instance in which an operator predicts and sets a measuring range of the wavelength of the excitation light and a measuring range of the wavelength of the emission light on the basis of the type and the property of the measurement sample is shown. Here, No. 1 shows an instance 1 in which the wavelength of the excitation light ranges from 300 nm to 400 nm, and the wavelength of the emission light ranges from 300 nm to 400 nm, and No. 2 shows an instance in which the wavelength of the excitation light ranges from 500 nm to 700 nm, and the wavelength of the emission light ranges from 700 nm to 800 nm. When the measurement sample is a mixed sample containing a plurality of components or when the measurement sample is predicted to have a plurality of excitation light wavelengths or emission light wavelengths according to the property of the measurement sample, a plurality of combinations of scanning wavelength ranges can be set. As described above, by employing a combination of a start wavelength and a stop wavelength of each of the measuring range of the wavelength of the excitation light and the measuring range of the wavelength of the emission light as one set, a plurality of sets of combinations can be set at the time of setting the measuring conditions. The fluorescence spectrophotometer performs automatic measurement according to the set contents, and stores the obtained data of a three-dimensional spectrum in the unillustrated storage section. In the embodiment of the present invention, the wavelength range can be preliminarily-specified before measurement, and the plurality of wavelength ranges can be automatically measured, so that a measuring time can be significantly shortened as compared to that in a conventional apparatus.

FIG. 3 is a graph showing a scanning region of the excitation light wavelength and the emission light wavelength. A horizontal axis represents an excitation light wavelength Ex, and a vertical axis represents an emission light wavelength Em. When a measurer intends to obtain only the emission light intensity in wavelength scanning regions shown in FIG. 2, it is necessary for the conventional apparatus to obtain the data of the emission light intensity by scanning all of regions 301, 302, 303, and 304, that is, scanning the wavelengths of the excitation light ranging from 300 nm to 700 nm, and scanning the wavelengths of the emission light ranging from 300 nm to 800 nm.

Meanwhile, in the present embodiment, when the settings of the wavelength scanning regions shown in FIG. 2 are input and instructed, the computer 122 instructs the respective sections of the photometer unit 110 to scan wavelengths only in the ranges of the regions 303 and 304, and thereby obtain the data of the emission light intensity therein.

Since the wavelength of the emission light is smaller than the wavelength of the excitation light, only the region 303 in which the excitation light wavelength is smaller than the emission light wavelength out of a region enclosed by a wavelength range having the wavelengths of the excitation light ranging from 300 nm to 400 nm and a wavelength range having the wavelengths of the emission light ranging from 300 nm to 400 nm in FIG. 3 is scanned and the data thereof is obtained, so that the time is shortened.

As described above, in the present embodiment, since any wavelength region can be selectively specified as a wavelength region whose data is desired to be obtained by an operator, such an advantage that the time required for obtaining the data is shortened, and the size of the obtained data is reduced as compared to the conventional case can be obtained.

Also, the scanning of wavelengths is often performed per 10 nm, and the data of the emission light intensity in this case is represented as a matrix per 10 nm on both the horizontal and vertical axes and stored in the unillustrated storage section. At this time, as for the data group stored in the storage section, a value indicating that no data is provided since measurement has not been performed, e.g., “zero” is written into the cells of the matrices of the regions 301 and 302 whose wavelengths are not scanned in FIG. 3. Accordingly, when the measurement data is displayed on the display section 131, it is possible to display the measurement data such that an unmeasured wavelength region is apparent at first sight by using the fact that the cells into which “zero” is written constitute the unmeasured wavelength region, and the operator is thereby enabled to determine the necessity of measurement in the unmeasured wavelength region.

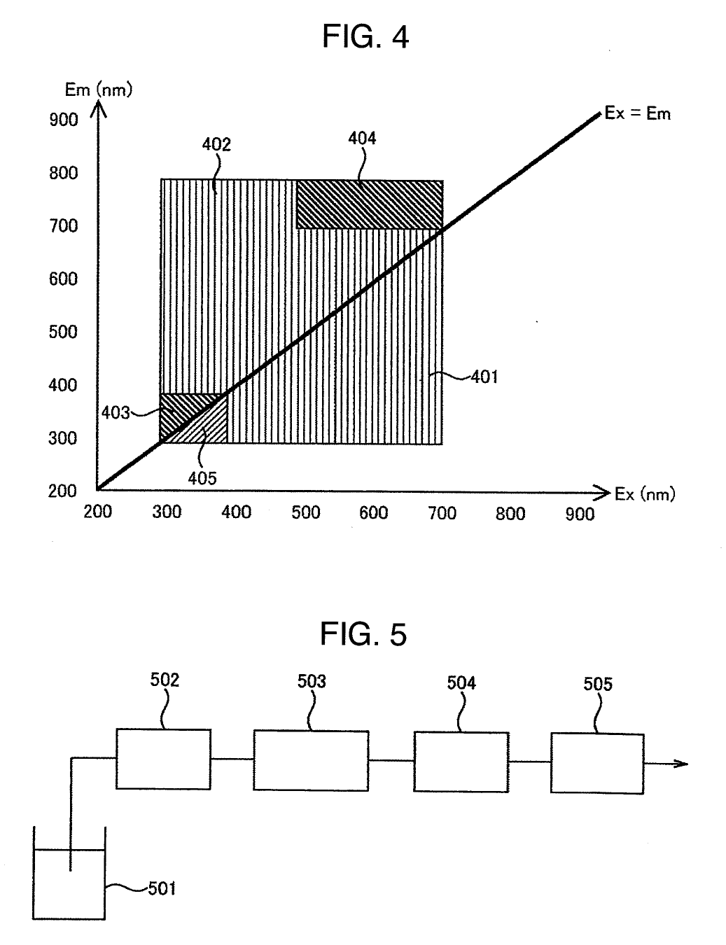

FIG. 4 is a graph showing a scanning region of the excitation light wavelength and the emission light wavelength in a similar manner to FIG. 3. FIG. 4 differs from FIG. 3 in that wavelengths in a region 405 out of the region 301 in which the excitation light wavelength is larger than the emission light wavelength are scanned. The case of the instance shown in FIG. 3 has the advantage that the time can be shortened since the wavelengths in the region 405 are not scanned. However, in a case of an apparatus in which such control as to operate the emission side pulse motor 119 to change the wavelength for starting the scanning of the emission light wavelength needs to be performed with the excitation light wavelength and the emission light wavelength being along the same line, a control program for the emission side pulse motor 119 out of programs executed by the computer 122 is rewritten.

Meanwhile, in the instance shown in FIG. 4, the scanning of the emission light wavelength is started from 300 nm, and the data is obtained only in a region 403. Therefore, only a timing of obtaining the data executed by the computer 122 may be changed without changing the control program for the emission side pulse motor 119 out of the programs executed by the computer 122. Accordingly, although the time required for the wavelength scanning is slightly longer than that in the instance shown in FIG. 3, the time can be significantly shortened as compared to the conventional case in which the data is obtained by scanning a wavelength region front surface.

As described above, with the embodiment of the present invention, the fluorescence spectrophotometer which can shorten the time required for measuring the three-dimensional spectrum in the sample, prevent deterioration in the sample, and reduce the data size can be obtained.

FIG. 5 is a configuration diagram illustrating a main configuration of a liquid chromatograph. The liquid chromatograph apparatus is an apparatus which separates components of a sample in a separation column while transferring the sample by an eluent, detects the sequentially transferred components by a detector, and thereby analyzes the components of the sample. The configuration shown in FIG. 5 will be described as one example thereof. The eluent is transferred by a liquid transfer device 502 such as a syringe pump from an eluent container 501 that stores the eluent for carrying a sample. A given amount of sample is injected into the eluent in a sample injection unit 503, and sent to a column 504. Since the flow speed differs depending on the type of the component of the sample in the eluent due to the action of a filling material filled inside a pipe of the column 504, the separated components sequentially flow out of the column 504. The sample components can be identified by detecting the emission light wavelengths of the components by use of, for example, the fluorescence spectrophotometer shown in FIG. 1 according to the embodiment of the present invention as a detector 505 that detects the components while causing the components to flow through a flow cell as a sample cell, and thereby creating a three-dimensional spectrum.

In a conventional detector, only start and end values can be set for the scanning range of the excitation light wavelength and the scanning range of the emission light wavelength. However, when the fluorescence spectrophotometer according to the present invention is used as the detector of the liquid chromatograph, the time from the start to the end of the wavelength scanning is shortened since it is possible to set and execute the scanning of only wavelengths required by an operator and the obtaining of the data. Accordingly, the number of wavelength scanning operations performed while the components are passing through the flow cell is increased even in an ultrafast liquid chromatograph in which the components flow at high speed, and the component identification accuracy is improved.

As described above, with the embodiment of the present invention, the fluorescence detector for a liquid chromatograph which can shorten the time required for measuring the three-dimensional spectrum in the sample, and improve the component identification accuracy can be obtained.

### REFERENCE SIGNS LIST

100 Fluorescence spectrophotometer, 110 Photometer unit, 111 Light source, 112 Excitation side spectroscope, 113 Beam splitter, 114 Monitor detector, 115 Sample installation section, 116 Emission side spectroscope, 117 Detector, 118 Excitation side pulse motor, 119 Emission side pulse motor, 120 Data processing unit, 121 A/D converter, 122 Computer, 130 Operation display unit, 131 Display section, 132 Operation section, 501 Eluent container, 502 Liquid transfer device, 503 Sample injection unit, 504 Column, 505 Detector

1. A fluorescence spectrophotometer comprising:
a sample cell housing a sample, components of the sample being analyzed;
an excitation light side spectroscope irradiating excitation light of a predetermined wavelength onto the sample cell;
an emission side spectroscope dispersing emission light from the sample cell by scanning a predetermined range of wavelengths;
an emission light detector detecting the emission light from the emission side spectroscope; and
a computer calculating a three-dimensional spectrum of an emission light intensity in the sample on the basis of a wavelength and an intensity of the emission light detected by the emission light detector while changing a wavelength of the excitation light irradiated onto the sample cell by the excitation light side spectroscope,
wherein the computer employs a plurality of combinations of a range of wavelengths of the excitation light dispersed by the excitation light side spectroscope and a range of wavelengths of the emission light dispersed by the emission side spectroscope.

2. The fluorescence spectrophotometer according to claim 1,
wherein the computer calculates the three-dimensional spectrum of the emission light intensity in the sample on the basis of the set combinations of the range of wavelengths of the excitation light dispersed by the excitation light side spectroscope and the range of wavelengths of the emission light dispersed by the emission side spectroscope.

3. The fluorescence spectrophotometer according to claim 1, further comprising
a storage section storing a data group composed of data of the three-dimensional spectrum calculated with respect to each of a plurality of combination sets, each of the combination sets formed by combining the range of wavelengths of the excitation light dispersed by the excitation light side spectroscope and the range of wavelengths of the emission light dispersed by the emission side spectroscope.

4. The fluorescence spectrophotometer according to claim 3,
wherein the data of the three-dimensional spectrum is stored in a cell of the storage section.

5. The fluorescence spectrophotometer according to claim 4,
wherein a value indicating that no data is provided is stored in a cell of the storage section excluding a cell, the calculated data of the three-dimensional spectrum being stored in the cell.

6. The fluorescence spectrophotometer according to claim 4,
wherein a value indicating that no measurement has been performed is stored in a cell corresponding to an unmeasured wavelength region of the storage section.

7. A fluorescence detector for a liquid chromatograph for use in a liquid chromatograph injecting a sample into an eluent, separating the sample into components in a separation column, and analyzing the components of the sample by detecting the components, the emission light detector comprising:
a sample cell, the components of the sample flowing through the sample cell;
an excitation light side spectroscope irradiating excitation light of a predetermined wavelength onto the sample cell;
an emission side spectroscope dispersing emission light from the sample cell by scanning a predetermined range of wavelengths;
an emission light detector detecting the emission light from the emission side spectroscope; and
a computer calculating a three-dimensional spectrum of an emission light intensity in the sample on the basis of a wavelength and an intensity of the emission light detected by the emission light detector while changing a wavelength of the excitation light irradiated onto the sample cell by the excitation light side spectroscope,
wherein the computer employs a plurality of combinations of a range of wavelengths of the excitation light dispersed by the excitation light side spectroscope and a range of wavelengths of the emission light dispersed by the emission side spectroscope.

8. The fluorescence detector for a liquid chromatograph according to claim 7,
wherein the computer calculates the three-dimensional spectrum of the emission light intensity in the sample on the basis of the set combinations of the range of wavelengths of the excitation light dispersed by the excitation light side spectroscope and the range of wavelengths of the emission light dispersed by the emission side spectroscope.
